(19) United States
(12) Patent Application Publication
(10) Pub. No.: US 2026/0313042 A1
(43) Pub. Date: Oct. 8, 2026

(54) COOPERATIVE COMPUTING REQUEST AND RESPONSE

(71) Applicant: QUALCOMM Incorporated, San Diego, CA (US)

(72) Inventors: Hua WANG, Basking Ridge, NJ (US); Qing LI, Princeton Junction, NJ (US); Navid ABEDINI, Basking Ridge, NJ (US); Sony AKKARAKARAN, Poway, CA (US); Igor GUTMAN, Hod HaSharon (IL); Qian ZHANG, Basking Ridge, NJ (US); Tao LUO, San Diego, CA (US); Junyi LI, Greentown, PA (US)

(21) Appl. No.: 19/545,988

(22) Filed: Feb. 20, 2026

Related U.S. Application Data
(60) Provisional application No. 63/783,799, filed on Apr. 4, 2025.

(51) Int. Cl. H04L 67/60; H04W 24/02

(52) U.S. Cl. CPC H04L 67/60; H04W 24/02

(57) ABSTRACT

Various aspects of the present disclosure generally relate to wireless communication. In some aspects, a serving device may receive, from a network, a request indicating that the serving device is being requested to perform a computing task on behalf of the network or for a client device. The serving device may transmit, to the network, a response to the request indicating whether the serving device accepts or rejects the request. Numerous other aspects are described.

### CROSS-REFERENCE TO RELATED APPLICATION

This Patent Application claims priority to U.S. Provisional Patent Application No. 63/783,799, filed on Apr. 4, 2025, entitled “COOPERATIVE COMPUTING REQUEST AND RESPONSE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with transmitting and receiving cooperative computing requests and responses.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Some computing tasks can be distributed across devices in a wireless network. For example, a large artificial intelligence or machine learning model, such as a large language model, may execute faster by using memory and processing resources available across multiple devices. In another example, a device with less power capacity or computing resources, such as a smartwatch, may have channel state feedback calculations performed by a paired device with more power capacity or computing resources, such as a user equipment.

### SUMMARY

The systems, methods, and devices of this disclosure each have several innovative aspects, no single one of which is solely responsible for the desirable attributes disclosed herein.

Some aspects described herein relate to a method of wireless communication performed by a serving device. The method may include receiving, from a network, a request indicating that the serving device is being requested to perform a computing task on behalf of the network or for a client device. The method may include transmitting, to the network, a response to the request indicating whether the serving device accepts or rejects the request.

Some aspects described herein relate to a method of wireless communication performed by a network node. The method may include transmitting, to a serving device, a request indicating that the serving device is being requested to perform a computing task on behalf of a network or for a client device. The method may include receiving, from the serving device, a response to the request indicating whether the serving device accepts or rejects the request.

Some aspects described herein relate to a serving device. The serving device may include one or more antennas and a processing system. The processing system may include one or more processors and one or more memories that store code and are coupled with the one or more processors. The processing system may be configured to cause the serving device to receive, from a network, a request indicating that the serving device is being requested to perform a computing task on behalf of the network or for a client device. The processing system may be configured to cause the serving device to transmit, to the network, a response to the request indicating whether the serving device accepts or rejects the request.

Some aspects described herein relate to a network node. The network node may include one or more antennas and a processing system. The processing system may include one or more processors and one or more memories that store code and are coupled with the one or more processors. The processing system may be configured to cause the network node to transmit, to a serving device, a request indicating that the serving device is being requested to perform a computing task on behalf of a network or for a client device. The processing system may be configured to cause the network node to receive, from the serving device, a response to the request indicating whether the serving device accepts or rejects the request.

Some aspects described herein relate to a non-transitory computer-readable medium that stores a set of instructions for wireless communication by a serving device. The set of instructions, when executed by one or more processors of the serving device, may cause the serving device to receive, from a network, a request indicating that the serving device is being requested to perform a computing task on behalf of the network or for a client device. The set of instructions, when executed by one or more processors of the serving device, may cause the serving device to transmit, to the network, a response to the request indicating whether the serving device accepts or rejects the request.

Some aspects described herein relate to a non-transitory computer-readable medium that stores a set of instructions for wireless communication by a network node. The set of instructions, when executed by one or more processors of the network node, may cause the network node to transmit, to a serving device, a request indicating that the serving device is being requested to perform a computing task on behalf of a network or for a client device. The set of instructions, when executed by one or more processors of the network node, may cause the network node to receive, from the serving device, a response to the request indicating whether the serving device accepts or rejects the request.

Some aspects described herein relate to an apparatus for wireless communication. The apparatus may include means for receiving, from a network, a request indicating that the apparatus is being requested to perform a computing task on behalf of the network or for a client device. The apparatus may include means for transmitting, to the network, a response to the request indicating whether the apparatus accepts or rejects the request.

Some aspects described herein relate to an apparatus for wireless communication. The apparatus may include means for transmitting, to a serving device, a request indicating that the serving device is being requested to perform a computing task on behalf of a network or for a client device. The apparatus may include means for receiving, from the serving device, a response to the request indicating whether the serving device accepts or rejects the request.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of cooperative computing in a wireless network.

FIG. 3 is a diagram illustrating an example associated with cooperative computing requests and responses.

FIG. 4 is a diagram illustrating an example process performed, for example, by a serving device.

FIG. 5 is a diagram illustrating an example process performed, for example, by a network node.

FIGS. 6 and 7 are diagrams of example apparatuses for wireless communication.

### DETAILED DESCRIPTION

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

In a wireless network, cooperative computing may include dividing a computing operation (e.g., a model) across multiple devices (e.g., by splitting the computing operation into multiple computing tasks). Cooperative computing may additionally, or alternatively, involve assignment of a computing operation for one device (e.g., a client user equipment (UE) or a network function) to a different device (e.g., a serving UE or an edge computing device).

Various aspects relate generally to a request indicating that a serving device is being requested to perform a computing task and a response indicating whether the serving device accepts or rejects the request. As used herein, “serving device” may refer to any device capable of performing a computing task and communicating a result of the computing task wirelessly to a network. In some aspects, the computing task may be performed on behalf of a network. Alternatively, the computing task may be performed for a client device. As used herein, “client device” may refer to any device capable of receiving a result of a computing task wirelessly from a network and processing the result. Some aspects more specifically relate to using layer 1 (L1), layer 2 (L2), or layer 3 (L3) signaling for the request. Alternatively, in some aspects, a paging message may be used for the request. Some aspects more specifically relate to using uplink control information for the response. Alternatively, in some aspects, a random access message or small data transmission (SDT) may be used for the response.

Particular aspects of the subject matter described in this disclosure can be implemented to realize one or more of the following potential advantages. In some examples, the described techniques can be used to enable a network to speed up execution of a model or another type of computing operation by utilizing memory and processing resources from multiple serving devices. Similarly, the described techniques can be used to enable the network to allow a client device to conserve power and computing resources by utilizing memory and processing resources from a serving device. In some aspects, using L1, L2, or L3 signaling for the request (along with uplink control information for the response) enables the network to request cooperative computing from UEs in a connected state. Using a paging message for the request (along with a random access message or SDT for the response) enables the network to request cooperative computing from UEs in an idle mode or an inactive state.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

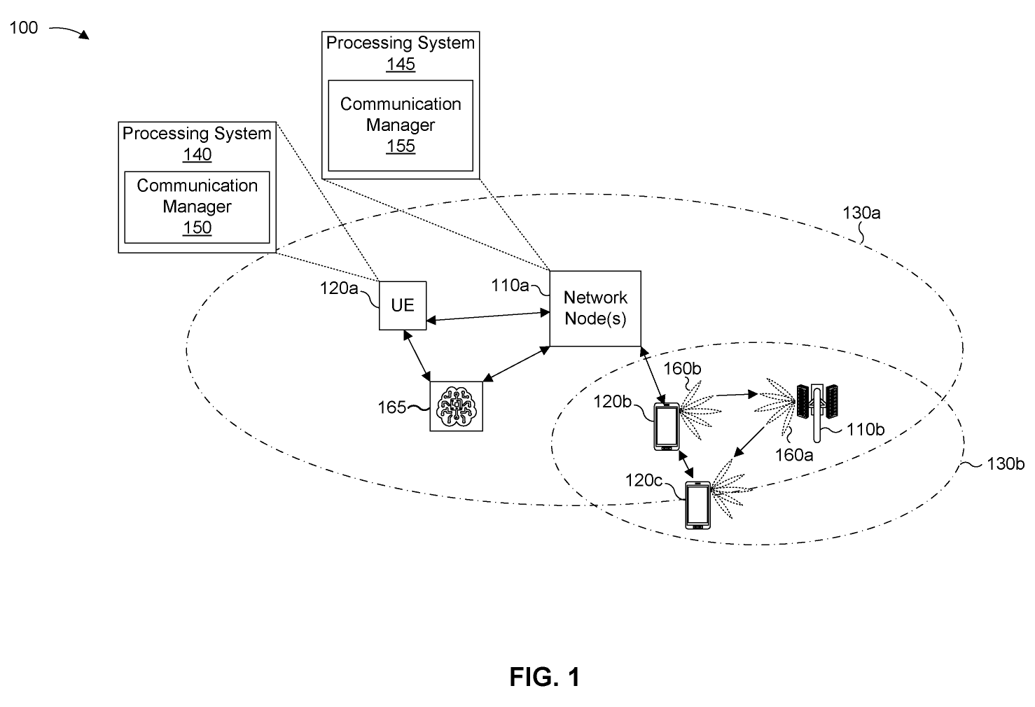

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

Devices in the wireless communication network 100 may participate in cooperative computing. For example, a client device may include a UE 120 that requests a computing task (or a set of computing tasks) be offloaded to a serving device (e.g., a different UE 120 or an edge computing device). As used herein, “edge computing device” may refer to a device on an edge of a core network supporting the network node 110 that processes the request from the client device. In order to process the request from the client device, the network node 110 may transmit a request to the serving device (or a set of serving devices), as described herein.

In some aspects, the UE 120 may include a processing system 140 with a communication manager 150. As described in more detail elsewhere herein, the communication manager 150 may receive (e.g., from the network node 110) a request indicating that the serving device is being requested to perform a computing task on behalf of a network (including the network node 110) or for a client device (e.g., a different UE 120) and may transmit (e.g., to the network node 110) a response to the request indicating whether the serving device accepts or rejects the request. Additionally, or alternatively, the communication manager 150 may perform one or more other operations described herein.

In some aspects, the network node 110 may include a processing system 145 with a communication manager 155. As described in more detail elsewhere herein, the communication manager 155 may transmit (e.g., to a serving device, such as the UE 120) a request indicating that the serving device is being requested to perform a computing task on behalf of a network or for a client device and may receive (e.g., from the serving device) a response to the request indicating whether the serving device accepts or rejects the request. Additionally, or alternatively, the communication manager 155 may perform one or more other operations described herein.

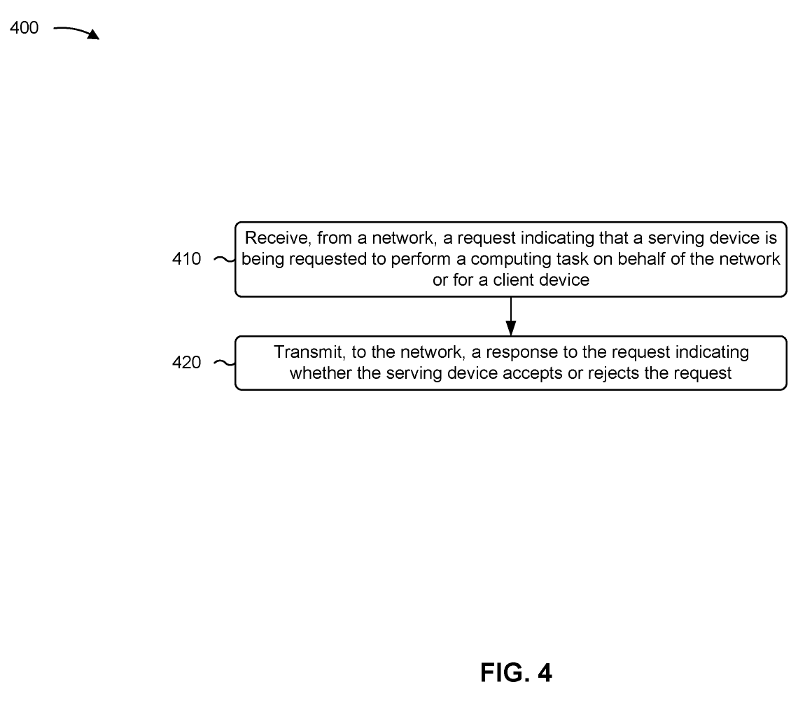

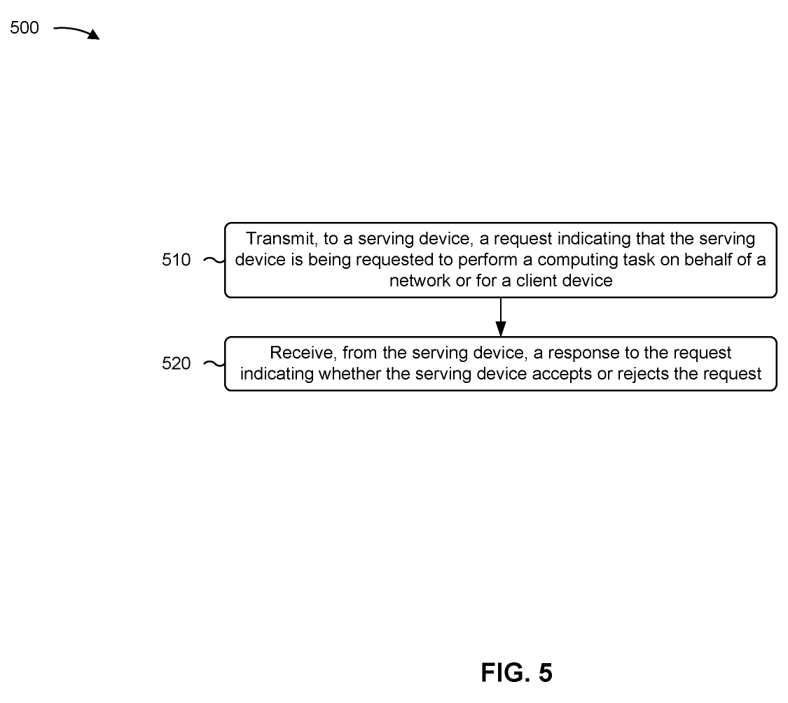

The network node 110, the processing system 145 of the network node 110, the UE 120, the processing system 140 of the UE 120, or any other component(s) of FIG. 1 may implement one or more techniques or perform one or more operations associated with transmitting and receiving cooperative computing requests and responses, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

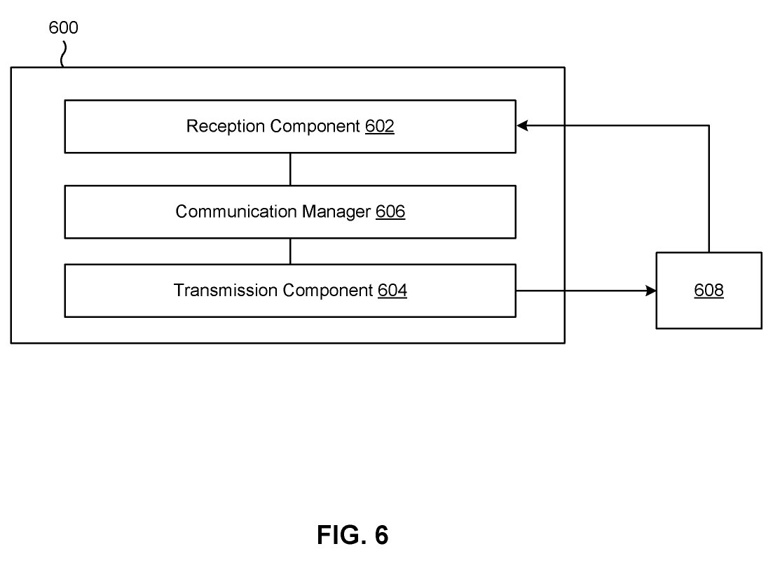

In some aspects, a serving device (e.g., the UE 120, an edge computing device, or apparatus 600 of FIG. 6) may include means for receiving, from a network, a request indicating that the serving device is being requested to perform a computing task on behalf of the network or for a client device and means for transmitting, to the network, a response to the request indicating whether the serving device accepts or rejects the request. In some aspects, the means for the serving device to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

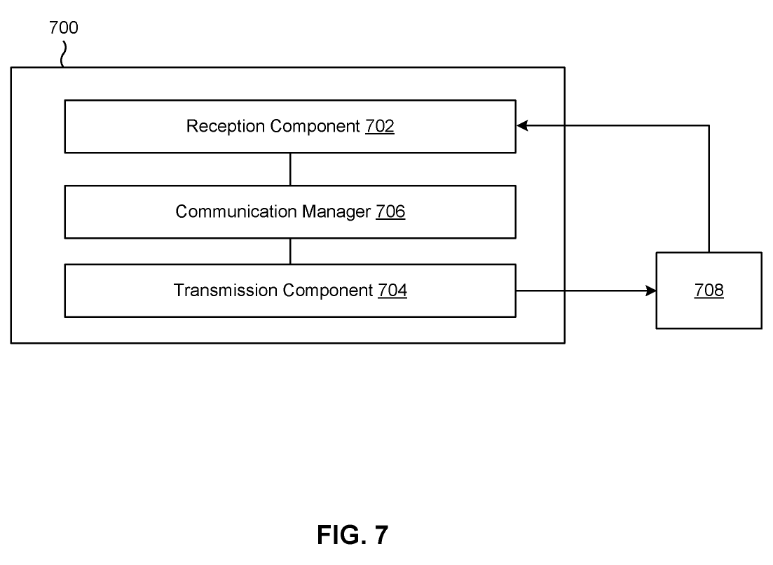

In some aspects, a network node (e.g., the network node 110 or apparatus 700 of FIG. 7) may include means for transmitting, to a serving device (e.g., the UE 120, an edge computing device, or apparatus 600 of FIG. 6), a request indicating that the serving device is being requested to perform a computing task on behalf of a network or for a client device (e.g., the UE 120 or apparatus 600 of FIG. 6) and means for receiving, from the serving device, a response to the request indicating whether the serving device accepts or rejects the request. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

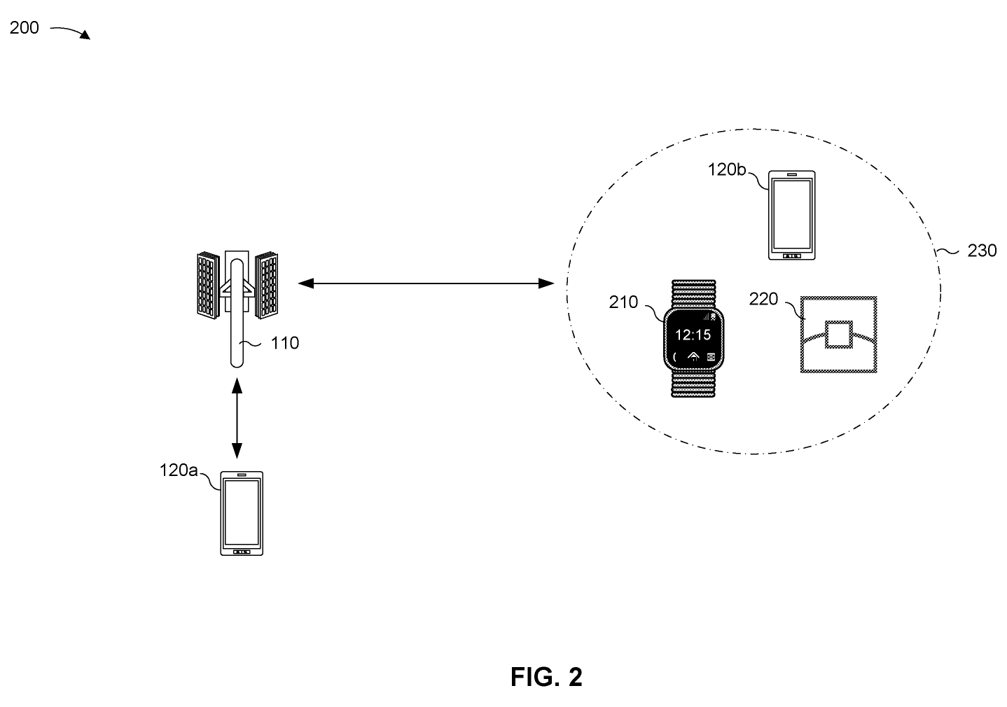

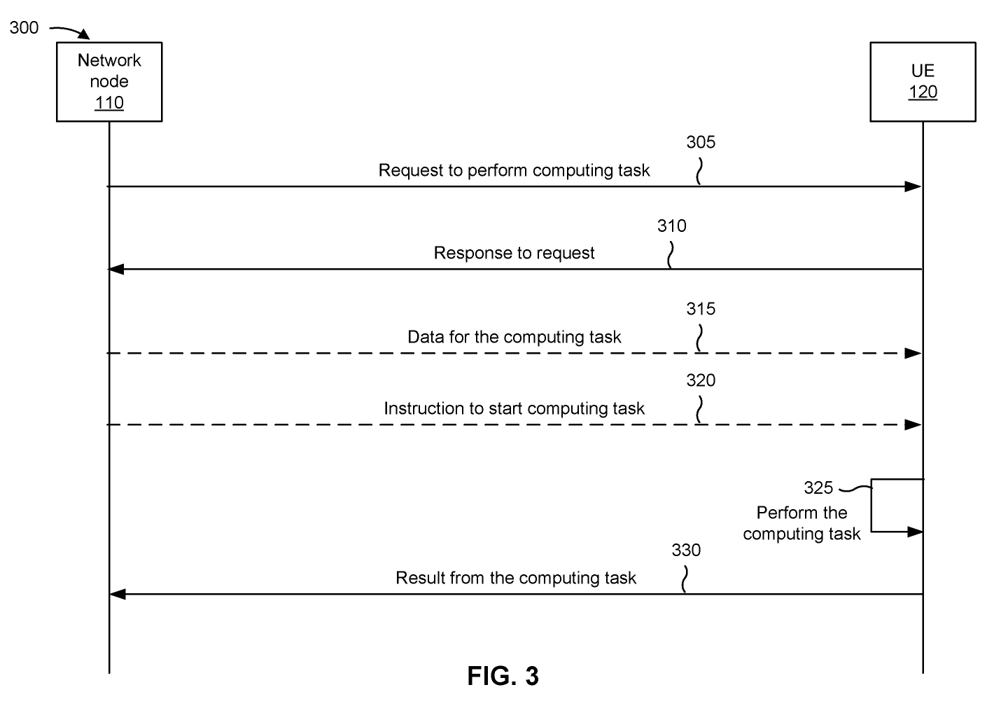

FIG. 2 is a diagram illustrating an example 200 of cooperative computing in a wireless network. As shown in FIG. 2, a client device (shown as UE 120a) may communicate with a network node 110 to request cooperative computing from a set of serving devices. The set of serving devices may include a UE 120b, an IoT device 210, or an edge computing device 220, among other examples. The network node 110 may, as described in connection with FIG. 3, communicate with the set of serving devices to request cooperative computing, and each serving device may accept or reject the request.

In one example, the set of serving devices may communicate with each other through a local network 230 in order to fulfil the request. The local network 230 may include a WiFi network or a sidelink connection, among other examples. Additionally, or alternatively, the set of serving devices may communicate with each other through the Internet or a core network supporting the network node 110, among other examples.

As indicated above, FIG. 2 is provided as an example. Other examples may differ from what is described with respect to FIG. 2.

FIG. 3 is a diagram illustrating an example 300 associated with cooperative computing requests and responses. As shown in FIG. 3, a network node 110 (e.g., an RU or a device controlling the RU, such as a DU or a CU) and a UE 120 may communicate with one another (e.g., OTA in a wireless network, such as the wireless communication network 100 of FIG. 1).

As shown by reference number 305, the network node 110 may transmit, and the UE 120 may receive, a request indicating that the UE 120 is being requested to perform a computing task. The computing task may be on behalf of a network (e.g., on behalf of a network function, such as a network computing service function (NWCSF), in a core network supporting the network node 110) or for a client device (e.g., a different UE 120). For example, the network node 110 may have received an indication of the computing task from the client device or from a function of the network, and the network node 110 may transmit the request in response to the indication.

In some aspects, the request may include an indication of one or more computing resources associated with the computing task. For example, the request may indicate trillions of operations per second (TeraOPS or TOPs) for the computing task or a desired accuracy associated with the computing task, among other examples. Additionally, or alternatively, the request may include an indication of a category of the computing task. For example, the request may indicate a class of problem to be solved when performing the computing task, such as multiplying large matrices, performing fast Fourier transformation (FFT), or identifying principal eigenvectors, among other examples. Additionally, or alternatively, the request may include an indication of a time constraint associated with the computing task. For example, the request may indicate a latency bound associated with the computing task, a period of time for which the computing task is requested (e.g., how long the UE 120 should remain awake or a periodic service requirement associated with the computing task), or a time to start the computing task (e.g., an absolute time, whether a particular slot or symbol, or a relative time, such as an offset relative to receiving the request or receiving input data for the computing task). Additionally, or alternatively, the request may include an indication of a type of the computing task. For example, the type may be an extended reality (XR) task or a large language model (LLM) task, among other examples. Additionally, or alternatively, the request may include an indication of a security protocol associated with the computing task. For example, the request may indicate that the computing task is for edge servers or cloud servers (and not for personal devices). Accordingly, the request may instruct the UE 120 to reject the request if the UE 120 is a personal device. Additionally, or alternatively, the request may include an indication of a price for the computing task (e.g., that the client device or the network will pay for completion of the computing task).

Rather than include explicit indications, the request may reference a table that defines one or more factors that are described above. For example, the table may be programmed into (or otherwise stored in a memory of) the network node 110 and the UE 120, such that the network node 110 may use an index (or another type of alphanumeric identifier) from the table to indicate information about the computing task. In another example, the UE 120 may provide the table to the network node 110 (e.g., during a registration process), such that the network node 110 may reference the table in the request.

The UE 120 may be in a connected state (e.g., an RRC connected state) with the network node 110. Therefore, the request may be included in a downlink control message. In one example, the request may be included in an L1 message (e.g., a PDCCH message, such as a computing wake-up signal (WUS) or DCI). In another example, the request may be included in an L2 message (e.g., a MAC-CE). The L2 message may be associated with a logical channel identifier (LCID) that is configured for cooperative computing. The L2 message may further indicate a status of the input data for the computing task (e.g., a size of the input data or whether the input data is ready, among other examples). In some aspects, the request may be encrypted using L1 or L2 security. For example, the network node 110 may determine to use an L1 message or an L2 message in response to the network node 110 and the UE 120 encrypting (or otherwise securing) L1 and L2 messages. In another example, the request may be included in an L3 message (e.g., an RRC message). The L3 message may include an information element (IE) associated with cooperative computing requests.

The UE 120 may instead be in an idle mode (e.g., an RRC idle mode) or an inactive state (e.g., an RRC inactive state). Therefore, the request may be included in a paging message. The paging message may be associated with computing requests (e.g., transmitted, and received, in a paging occasion (PO) dedicated to computing requests). Alternatively, the paging message may be associated with communication (e.g., transmitted, and received, in a PO used to trigger communication from the network node 110 to the UE 120). In some aspects, the request may be transmitted, and received, during an off period associated with discontinuous reception (DRX) and during a computing active period of the UE 120. For example, the UE 120 may be configured for DRX and have a period, overlapping at least partially with the DRX off period, during which the UE 120 may perform cooperative computing tasks (thus referred to as the “computing active period”). The paging message may include a cause value indicating that the paging message is for the computing task. Additionally, or alternatively, the paging message may indicate whether the computing task is on behalf of the network or is for the client device. In some aspects, the network node 110 may transmit, and the UE 120 may receive, a paging early indication (PEI) that indicates that the paging message including the request will be transmitted. The PEI may be associated with computing requests (e.g., indicating that the paging message will be transmitted, and received, in a PO dedicated to computing requests). Alternatively, the PEI may be associated with communication (e.g., indicating that the paging message will be transmitted, and received, in a PO used to trigger communication from the network node 110 to the UE 120). In some aspects, the network node 110 may provide information associated with the computing task (e.g., indications of factors associated with the computing task, as described above) in a random access message (e.g., a Msg2 or a Msg4 during a random access procedure triggered by the paging message) or a small data transmission (SDT). As used herein, “SDT” refers to a procedure by which the network node 110 and the UE 120 may communicate while the UE 120 remains in an inactive state (e.g., with the UE 120 transitioning to a connected state).

As shown by reference number 310, the UE 120 may transmit, and the network node 110 may receive, a response to the request indicating whether the UE 120 accepts or rejects the request. The UE 120 may be in a connected state (e.g., an RRC connected state) with the network node 110. Therefore, the request may be included in an uplink control message (e.g., a PDCCH message, such as a UCI). In some aspects, the response may be transmitted, and received, in a set of resources (e.g., frequency resources, time resources, spatial resources, or a combination thereof) that was indicated by the request. In some aspects, the response may be encrypted using L1 or L2 security. For example, the UE 120 may determine to use an L1 message or an L2 message in response to the network node 110 and the UE 120 encrypting (or otherwise securing) L1 and L2 messages.

The UE 120 may instead be in an idle mode (e.g., an RRC idle mode) or an inactive state (e.g., an RRC inactive state). Therefore, the request may be included in a random access message (e.g., a Msg3 during a random access procedure triggered by the request) or an SDT. In some aspects, the request may indicate whether the UE 120 should establish a connection with the network node 110 (e.g., transition to an RRC connected state) in order to receive the input data for the computing task (or to start the computing task if the input data is included in the request or otherwise already available). If not, the UE 120 may return to a sleep mode (or another type of low-power mode) after transmitting the response and may await an additional paging message (e.g., indicating that the input data will be transmitted or instructing the UE 120 to start the computing task).

In some aspects, the response may indicate a time constraint associated with the UE 120. For example, the response may indicate a period of time for which the UE 120 may perform the computing task (e.g., how long the UE 120 may remain awake or fulfil a periodic service requirement associated with the computing task), or how long until the UE 120 may start the computing task (e.g., an absolute time, whether a particular slot or symbol, or a relative time, such as an offset relative to receiving the request or receiving input data for the computing task). Additionally, or alternatively, the response may include an indication of a price for the computing task (e.g., that the UE 120 will charge for completion of the computing task).

Although the example 300 is described in connection with a unicast request from the network node 110, other examples may include a multicast request from the network node 110. For example, a group of devices, including the UE 120, may receive a group PDCCH message (e.g., when the group of devices are in a connected state) or a group paging message (e.g., when the group of devices are in an idle mode, an inactive state, or a combination thereof). In some aspects, the request may indicate different computing tasks for different devices in the group of devices. For example, the network node 110 may transmit a common multicast message, but each device in the group of devices may extract a portion of the message corresponding to the device. In one example, the network node 110 may request different devices in the group to host different layers of an inference model (e.g., an LLM model). Alternatively, the request may indicate a same computing task for each device in the group of devices. Therefore, if multiple devices accept the request, the network node 110 may downselect one or more devices from whichever devices accepted (e.g., if fewer devices are to be used for the computing task than accepted).

If the UE 120 accepted the request, the UE 120 may await the input data for the computing task. Accordingly, as shown by reference number 315, the network node 110 may transmit, and the UE 120 may receive, the input data. Alternatively, the UE 120 may perform the computing task without waiting (e.g., skipping to reference number 325) when the input data was included in the request, was previously sent from the network node 110 to the UE 120, or was programmed into (or otherwise stored in a memory of) the UE 120. The UE 120 may start the computing task according to a time indicated in the request.

Rather than perform the computing task without waiting, the UE 120 may await an instruction to start. Accordingly, as shown by reference number 320, the network node 110 may transmit, and the UE 120 may receive, an instruction to start the computing task. For example, the network node 110 may multicast the request such that the network node 110 may downselect from accepting devices using the instruction to start. In some aspects, the request may explicitly indicate that the UE 120 should await the instruction. As shown by reference number 325, the UE 120 may perform the computing task in response to the instruction.

Although the example 300 is described in connection with the UE 120, other examples may include the UE 120 cooperating with other serving devices to perform the computing task. Accordingly, the network node 110 may transmit, and the UE 120 may receive, a resource allocation associated with at least one additional serving device. The resource allocation may include a sidelink allocation or another type of allocation that enables the UE 120 to communicate with the additional serving device(s). Therefore, the UE 120 may communicate with the additional serving device(s), using the resource allocation, in order to perform the computing task.

As shown by reference number 330, the UE 120 may transmit, and the network node 110 may receive, output data based at least in part on performing the computing task. By using techniques as described in connection with FIG. 3, the network node 110 may speed up execution of the computing task by utilizing memory and processing resources from the UE 120. Similarly, the network node 110 enables the core network or the client device to conserve power and computing resources by utilizing memory and processing resources from the UE 120.

As indicated above, FIG. 3 is provided as an example. Other examples may differ from what is described with respect to FIG. 3. For example, in FIG. 3, a serving device is depicted as the UE 120. However, other serving devices may be used, such as an edge computing device.

FIG. 4 is a diagram illustrating an example process 400 performed, for example, at a serving device or an apparatus of a serving device. Example process 400 is an example where the apparatus or the serving device (e.g., UE 120) performs operations associated with receiving and responding to a cooperative computing request.

As shown in FIG. 4, in some aspects, process 400 may include receiving, from a network, a request indicating that the serving device is being requested to perform a computing task on behalf of the network or for a client device (block 410). For example, the serving device (e.g., using reception component 602 or communication manager 606, depicted in FIG. 6) may receive, from a network, a request indicating that the serving device is being requested to perform a computing task on behalf of the network or for a client device, as described herein.

As further shown in FIG. 4, in some aspects, process 400 may include transmitting, to the network, a response to the request indicating whether the serving device accepts or rejects the request (block 420). For example, the serving device (e.g., using transmission component 604 or communication manager 606, depicted in FIG. 6) may transmit, to the network, a response to the request indicating whether the serving device accepts or rejects the request, as described herein.

Process 400 may include additional aspects, such as any single aspect or any combination of aspects described below or in connection with one or more other processes described elsewhere herein.

In a first aspect, the serving device includes a UE.

In a second aspect, alone or in combination with the first aspect, the serving device includes an edge computing device.

In a third aspect, alone or in combination with one or more of the first and second aspects, receiving the request includes receiving an indication of one or more computing resources associated with the computing task.

In a fourth aspect, alone or in combination with one or more of the first through third aspects, receiving the request includes receiving an indication of a category of the computing task.

In a fifth aspect, alone or in combination with one or more of the first through fourth aspects, receiving the request includes receiving an indication of a time constraint associated with the computing task.

In a sixth aspect, alone or in combination with one or more of the first through fifth aspects, receiving the request includes receiving an indication of a type of the computing task.

In a seventh aspect, alone or in combination with one or more of the first through sixth aspects, receiving the request includes receiving an indication of a security protocol associated with the computing task.

In an eighth aspect, alone or in combination with one or more of the first through seventh aspects, the request references a table that defines one or more of one or more computing resources associated with the computing task, a category of the computing task, a time constraint associated with the computing task, a type of the computing task, or a security protocol associated with the computing task.

In a ninth aspect, alone or in combination with one or more of the first through eighth aspects, the request includes DCI.

In a tenth aspect, alone or in combination with one or more of the first through ninth aspects, the request includes a MAC-CE.

In an eleventh aspect, alone or in combination with one or more of the first through tenth aspects, the request is encrypted using L1 or L2 security.

In a twelfth aspect, alone or in combination with one or more of the first through eleventh aspects, the request includes an RRC message.

In a thirteenth aspect, alone or in combination with one or more of the first through twelfth aspects, receiving the request includes receiving a paging message that includes the request.

In a fourteenth aspect, alone or in combination with one or more of the first through thirteenth aspects, the paging message is associated with computing requests.

In a fifteenth aspect, alone or in combination with one or more of the first through fourteenth aspects, the request is received during an off period associated with discontinuous reception and during a computing active period of the serving device.

In a sixteenth aspect, alone or in combination with one or more of the first through fifteenth aspects, the paging message is associated with communication.

In a seventeenth aspect, alone or in combination with one or more of the first through sixteenth aspects, the paging message includes a cause value indicating that the paging message is for the computing task.

In an eighteenth aspect, alone or in combination with one or more of the first through seventeenth aspects, process 400 includes receiving (e.g., using reception component 602 or communication manager 606) a paging early indication that indicates that the paging message including the request will be transmitted.

In a nineteenth aspect, alone or in combination with one or more of the first through eighteenth aspects, process 400 includes receiving (e.g., using reception component 602 or communication manager 606) information associated with the computing task in a random access message or an SDT.

In a twentieth aspect, alone or in combination with one or more of the first through nineteenth aspects, the response includes UCI.

In a twenty-first aspect, alone or in combination with one or more of the first through twentieth aspects, transmitting the response includes transmitting the response in a set of resources that was indicated by the request.

In a twenty-second aspect, alone or in combination with one or more of the first through twenty-first aspects, transmitting the response includes transmitting a random access message that includes the response.

In a twenty-third aspect, alone or in combination with one or more of the first through twenty-second aspects, transmitting the response includes transmitting an SDT that includes the response.

In a twenty-fourth aspect, alone or in combination with one or more of the first through twenty-third aspects, the response is encrypted using L1 or L2 security.

In a twenty-fifth aspect, alone or in combination with one or more of the first through twenty-fourth aspects, the request is multicast to a group of devices including the serving device.

In a twenty-sixth aspect, alone or in combination with one or more of the first through twenty-fifth aspects, the request indicates different computing tasks for different devices in the group of devices.

In a twenty-seventh aspect, alone or in combination with one or more of the first through twenty-sixth aspects, the request indicates a same computing task for each device in the group of devices.

In a twenty-eighth aspect, alone or in combination with one or more of the first through twenty-seventh aspects, process 400 includes receiving (e.g., using reception component 602 or communication manager 606), from the network, input data for the computing task, and transmitting (e.g., using transmission component 604 or communication manager 606), to the network, output data based at least in part on performing the computing task.

In a twenty-ninth aspect, alone or in combination with one or more of the first through twenty-eighth aspects, process 400 includes performing the computing task (e.g., using communication manager 606) using input data included in the request, and transmitting (e.g., using transmission component 604 or communication manager 606), to the network, output data based at least in part on performing the computing task.

In a thirtieth aspect, alone or in combination with one or more of the first through twenty-ninth aspects, process 400 includes receiving (e.g., using reception component 602 or communication manager 606), from the network, an instruction to start the computing task, and performing the computing task (e.g., using communication manager 606) in response to the instruction.

In a thirty-first aspect, alone or in combination with one or more of the first through thirtieth aspects, process 400 includes receiving (e.g., using reception component 602 or communication manager 606), from the network, a resource allocation associated with at least one additional serving device, and communicating (e.g., e.g., using reception component 602, transmission component 604, or communication manager 606) with the at least one additional serving device, using the resource allocation, to perform the computing task.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with transmitting a cooperative computing request and receiving a response thereto.

As shown in FIG. 5, in some aspects, process 500 may include transmitting, to a serving device, a request indicating that the serving device is being requested to perform a computing task on behalf of a network or for a client device (block 510). For example, the network node (e.g., using transmission component 704 or communication manager 706, depicted in FIG. 7) may transmit, to a serving device, a request indicating that the serving device is being requested to perform a computing task on behalf of a network or for a client device, as described herein.

As further shown in FIG. 5, in some aspects, process 500 may include receiving, from the serving device, a response to the request indicating whether the serving device accepts or rejects the request (block 520). For example, the network node (e.g., using reception component 702 or communication manager 706, depicted in FIG. 7) may receive, from the serving device, a response to the request indicating whether the serving device accepts or rejects the request, as described herein.

Process 500 may include additional aspects, such as any single aspect or any combination of aspects described below or in connection with one or more other processes described elsewhere herein.

In a first aspect, process 500 includes receiving an indication of the computing task from the client device, such that the request is transmitted in response to the indication.

In a second aspect, alone or in combination with the first aspect, process 500 includes receiving an indication of the computing task from a function of the network, such that the request is transmitted in response to the indication.

In a third aspect, alone or in combination with one or more of the first and second aspects, transmitting the request includes transmitting an indication of one or more computing resources associated with the computing task.

In a fourth aspect, alone or in combination with one or more of the first through third aspects, transmitting the request includes transmitting an indication of a category of the computing task.

In a fifth aspect, alone or in combination with one or more of the first through fourth aspects, transmitting the request includes transmitting an indication of a time constraint associated with the computing task.

In a sixth aspect, alone or in combination with one or more of the first through fifth aspects, transmitting the request includes transmitting an indication of a type of the computing task.

In a seventh aspect, alone or in combination with one or more of the first through sixth aspects, transmitting the request includes transmitting an indication of a security protocol associated with the computing task.

In an eighth aspect, alone or in combination with one or more of the first through seventh aspects, the request references a table that defines one or more of one or more computing resources associated with the computing task, a category of the computing task, a time constraint associated with the computing task, a type of the computing task, or a security protocol associated with the computing task.

In a ninth aspect, alone or in combination with one or more of the first through eighth aspects, the request includes DCI.

In a tenth aspect, alone or in combination with one or more of the first through ninth aspects, the request includes a MAC-CE.

In an eleventh aspect, alone or in combination with one or more of the first through tenth aspects, the request is encrypted using L1 or L2 security.

In a twelfth aspect, alone or in combination with one or more of the first through eleventh aspects, the request includes an RRC message.

In a thirteenth aspect, alone or in combination with one or more of the first through twelfth aspects, transmitting the request includes transmitting a paging message that includes the request.

In a fourteenth aspect, alone or in combination with one or more of the first through thirteenth aspects, the paging message is associated with computing requests.

In a fifteenth aspect, alone or in combination with one or more of the first through fourteenth aspects, the request is transmitted during an off period associated with discontinuous reception and during a computing active period of the serving device.

In a sixteenth aspect, alone or in combination with one or more of the first through fifteenth aspects, the paging message is associated with communication.

In a seventeenth aspect, alone or in combination with one or more of the first through sixteenth aspects, the paging message includes a cause value indicating that the paging message is for the computing task.

In an eighteenth aspect, alone or in combination with one or more of the first through seventeenth aspects, process 500 includes transmitting (e.g., using transmission component 704 or communication manager 706) a paging early indication that indicates that the paging message including the request will be transmitted.

In a nineteenth aspect, alone or in combination with one or more of the first through eighteenth aspects, process 500 includes transmitting (e.g., using transmission component 704 or communication manager 706) information associated with the computing task in a random access message or an SDT.

In a twentieth aspect, alone or in combination with one or more of the first through nineteenth aspects, the response includes UCI.

In a twenty-first aspect, alone or in combination with one or more of the first through twentieth aspects, receiving the response includes receiving the response in a set of resources that was indicated by the request.

In a twenty-second aspect, alone or in combination with one or more of the first through twenty-first aspects, receiving the response includes receiving a random access message that includes the response.

In a twenty-third aspect, alone or in combination with one or more of the first through twenty-second aspects, receiving the response includes receiving an SDT that includes the response.

In a twenty-fourth aspect, alone or in combination with one or more of the first through twenty-third aspects, the response is encrypted using L1 or L2 security.

In a twenty-fifth aspect, alone or in combination with one or more of the first through twenty-fourth aspects, the request is multicast to a group of devices including the serving device.

In a twenty-sixth aspect, alone or in combination with one or more of the first through twenty-fifth aspects, the request indicates different computing tasks for different devices in the group of devices.

In a twenty-seventh aspect, alone or in combination with one or more of the first through twenty-sixth aspects, the request indicates a same computing task for each device in the group of devices.

In a twenty-eighth aspect, alone or in combination with one or more of the first through twenty-seventh aspects, process 500 includes transmitting (e.g., using transmission component 704 or communication manager 706), to the serving device, input data for the computing task, and receiving (e.g., using reception component 702 or communication manager 706), from the serving device, output data based at least in part on completion of the computing task.

In a twenty-ninth aspect, alone or in combination with one or more of the first through twenty-eighth aspects, input data for the computing task is included in the request, and process 500 includes receiving (e.g., using reception component 702 or communication manager 706), from the serving device, output data based at least in part on completion of the computing task.

In a thirtieth aspect, alone or in combination with one or more of the first through twenty-ninth aspects, process 500 includes transmitting (e.g., using transmission component 704 or communication manager 706), to the serving device, an instruction to start the computing task.

In a thirty-first aspect, alone or in combination with one or more of the first through thirtieth aspects, process 500 includes transmitting (e.g., using transmission component 704 or communication manager 706), to the serving device, a resource allocation associated with at least one additional serving device, where the computing task is associated with cooperation between the serving device and the at least one additional serving device.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a serving device, or a serving device may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the serving device.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 or one or more components shown in FIG. 6 may include one or more components of the serving device described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the serving device described above in connection with FIG. 1, such as a radio, one or more RF chains, one or more transceivers, or one or more modems, each of which may in turn be coupled with one or more antennas of the serving device.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the serving device described above in connection with FIG. 1, such as a radio, one or more RF chains, one or more transceivers, or one or more modems, each of which may in turn be coupled with one or more antennas of the serving device described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

In some aspects, the reception component 602 may receive (e.g., from the apparatus 608) a request indicating that the apparatus 600 is being requested to perform a computing task on behalf of a network or for a client device. The transmission component 604 may transmit (e.g., to the apparatus 608) a response to the request indicating whether the serving device accepts or rejects the request.

In some aspects, the reception component 602 may receive (e.g., from the apparatus 608) a paging early indication that indicates that a paging message including the request will be transmitted. Additionally, or alternatively, the reception component 602 may receive (e.g., from the apparatus 608) information associated with the computing task in a random access message or a small data transmission.

In some aspects, the reception component 602 may receive (e.g., from the apparatus 608) input data for the computing task. Additionally, or alternatively, the reception component 602 may receive (e.g., from the apparatus 608) an instruction to start the computing task. The communication manager 606 may perform the computing task (e.g., using the input data received from the apparatus 608, whether in the request or separately). In some aspects, the communication manager 606 may perform the computing task in response to the instruction.

In some aspects, the reception component 602 may receive (e.g., from the apparatus 608) a resource allocation associated with at least one additional serving device. Accordingly, the reception component 602, the transmission component 604, or a combination thereof may communicate with the at least one additional serving device, using the resource allocation, to perform the computing task.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node, or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

In some aspects, the transmission component 704 may transmit (e.g., to the apparatus 708) a request indicating that the serving device is being requested to perform a computing task on behalf of a network or for a client device. The reception component 702 may receive (e.g., from the apparatus 708) a response to the request indicating whether the serving device accepts or rejects the request.

In some aspects, the reception component 702 may receive an indication of the computing task from the client device, such that the transmission component 704 transmits the request in response to the indication. Alternatively, the reception component 702 may receive an indication of the computing task from a function of the network, such that the transmission component 704 transmits the request in response to the indication.

In some aspects, the transmission component 704 may transmit (e.g., to the apparatus 708) a paging early indication that indicates that a paging message including the request will be transmitted. Additionally, or alternatively, the transmission component 704 may transmit (e.g., to the apparatus 708) information associated with the computing task in a random access message or an SDT.

In some aspects, the transmission component 704 may transmit (e.g., to the apparatus 708) input data for the computing task. Additionally, or alternatively, the transmission component 704 may transmit (e.g., to the apparatus 708) an instruction to start the computing task. The reception component 702 may receive (e.g., from the apparatus 708) output data based at least in part on completion of the computing task.

In some aspects, the transmission component 704 may transmit (e.g., to the apparatus 708) a resource allocation associated with at least one additional serving device. For example, the computing task may be associated with cooperation between the apparatus 708 and the at least one additional serving device.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

### The following provides an overview of some Aspects of the present disclosure:

Aspect 1: A method of wireless communication performed by a serving device, comprising: receiving, from a network, a request indicating that the serving device is being requested to perform a computing task on behalf of the network or for a client device; and transmitting, to the network, a response to the request indicating whether the serving device accepts or rejects the request.

Aspect 2: The method of Aspect 1, wherein the serving device comprises a user equipment.

Aspect 3: The method of Aspect 1, wherein the serving device comprises an edge computing device.

Aspect 4: The method of any of Aspects 1-3, wherein receiving the request comprises: receiving an indication of one or more computing resources associated with the computing task.

Aspect 5: The method of any of Aspects 1-4, wherein receiving the request comprises: receiving an indication of a category of the computing task.

Aspect 6: The method of any of Aspects 1-5, wherein receiving the request comprises: receiving an indication of a time constraint associated with the computing task.

Aspect 7: The method of any of Aspects 1-6, wherein receiving the request comprises: receiving an indication of a type of the computing task.

Aspect 8: The method of any of Aspects 1-7, wherein receiving the request comprises: receiving an indication of a security protocol associated with the computing task.

Aspect 9: The method of any of Aspects 1-3, wherein the request references a table that defines one or more of: one or more computing resources associated with the computing task; a category of the computing task; a time constraint associated with the computing task; a type of the computing task; or a security protocol associated with the computing task.

Aspect 10: The method of any of Aspects 1-9, wherein the request comprises downlink control information.

Aspect 11: The method of any of Aspects 1-9, wherein the request comprises a medium access control (MAC) control element.

Aspect 12: The method of any of Aspects 1-11, wherein the request is encrypted using layer 1 or layer 2 security.

Aspect 13: The method of any of Aspects 1-9, wherein the request comprises a radio resource control message.

Aspect 14: The method of any of Aspects 1-9, wherein receiving the request comprises: receiving a paging message that includes the request.

Aspect 15: The method of Aspect 14, wherein the paging message is associated with computing requests.

Aspect 16: The method of Aspect 14, wherein the paging message is associated with communication.

Aspect 17: The method of any of Aspects 14-16, wherein the request is received during an off period associated with discontinuous reception and during a computing active period of the serving device.

Aspect 18: The method of any of Aspects 14-17, wherein the paging message includes a cause value indicating that the paging message is for the computing task.

Aspect 19: The method of any of Aspects 14-18, further comprising: receiving a paging early indication that indicates that the paging message including the request will be transmitted.

Aspect 20: The method of any of Aspects 14-19, further comprising: receiving information associated with the computing task in a random access message or a small data transmission.

Aspect 21: The method of any of Aspects 1-20, wherein the response comprises uplink control information.

Aspect 22: The method of any of Aspects 1-21, wherein transmitting the response comprises: transmitting the response a set of resources that was indicated by the request.

Aspect 23: The method of any of Aspects 1-20, wherein transmitting the response comprises: transmitting a random access message that includes the response.

Aspect 24: The method of any of Aspects 1-20, wherein transmitting the response comprises: transmitting a small data transmission that includes the response.

Aspect 25: The method of any of Aspects 1-24, wherein the response is encrypted using layer 1 or layer 2 security.

Aspect 26: The method of any of Aspects 1-25, wherein the request is multicast to a group of devices including the serving device.

Aspect 27: The method of Aspect 26, wherein the request indicates different computing tasks for different devices in the group of devices.

Aspect 28: The method of Aspect 26, wherein the request indicates a same computing task for each device in the group of devices.

Aspect 29: The method of any of Aspects 1-28, further comprising: receiving, from the network, input data for the computing task; and transmitting, to the network, output data based at least in part on performing the computing task.

Aspect 30: The method of any of Aspects 1-28, further comprising: performing the computing task using input data included in the request; and transmitting, to the network, output data based at least in part on performing the computing task.

Aspect 31: The method of any of Aspects 1-28, further comprising: receiving, from the network, an instruction to start the computing task; and performing the computing task in response to the instruction.

Aspect 32: The method of any of Aspects 1-31, further comprising: receiving, from the network, a resource allocation associated with at least one additional serving device; and communicating with the at least one additional serving device, using the resource allocation, to perform the computing task.

Aspect 33: A method of wireless communication performed by a network node, comprising: transmitting, to a serving device, a request indicating that the serving device is being requested to perform a computing task on behalf of a network or for a client device; and receiving, from the serving device, a response to the request indicating whether the serving device accepts or rejects the request.

Aspect 34: The method of Aspect 33, further comprising: receiving an indication of the computing task from the client device, wherein the request is transmitted in response to the indication.

Aspect 35: The method of Aspect 33, further comprising: receiving an indication of the computing task from a function of the network, wherein the request is transmitted in response to the indication.

Aspect 36: The method of any of Aspects 33-35, wherein transmitting the request comprises: transmitting an indication of one or more computing resources associated with the computing task.

Aspect 37: The method of any of Aspects 33-36, wherein transmitting the request comprises: transmitting an indication of a category of the computing task.

Aspect 38: The method of any of Aspects 33-37, wherein transmitting the request comprises: transmitting an indication of a time constraint associated with the computing task.

Aspect 39: The method of any of Aspects 33-38, wherein transmitting the request comprises: transmitting an indication of a type of the computing task.

Aspect 40: The method of any of Aspects 33-39, wherein transmitting the request comprises: transmitting an indication of a security protocol associated with the computing task.

Aspect 41: The method of any of Aspects 33-35, wherein the request references a table that defines one or more of: one or more computing resources associated with the computing task; a category of the computing task; a time constraint associated with the computing task; a type of the computing task; or a security protocol associated with the computing task.

Aspect 42: The method of any of Aspects 33-41, wherein the request comprises downlink control information.

Aspect 43: The method of any of Aspects 33-41, wherein the request comprises a medium access control (MAC) control element.

Aspect 44: The method of any of Aspects 33-43, wherein the request is encrypted using layer 1 or layer 2 security.

Aspect 45: The method of any of Aspects 33-41, wherein the request comprises a radio resource control message.

Aspect 46: The method of any of Aspects 33-45, wherein transmitting the request comprises: transmitting a paging message that includes the request.

Aspect 47: The method of Aspect 46, wherein the paging message is associated with computing requests.

Aspect 48: The method of Aspect 46, wherein the paging message is associated with communication.

Aspect 49: The method of any of Aspects 46-48, wherein the request is transmitted during an off period associated with discontinuous reception and during a computing active period of the serving device.

Aspect 50: The method of any of Aspects 46-49, wherein the paging message includes a cause value indicating that the paging message is for the computing task.

Aspect 51: The method of any of Aspects 46-50, further comprising: transmitting a paging early indication that indicates that the paging message including the request will be transmitted.

Aspect 52: The method of any of Aspects 46-51, further comprising: transmitting information associated with the computing task in a random access message or a small data transmission.

Aspect 53: The method of any of Aspects 33-52, wherein the response comprises uplink control information.

Aspect 54: The method of any of Aspects 33-53, wherein receiving the response comprises receiving the response in a set of resources that was indicated by the request.

Aspect 55: The method of any of Aspects 33-52, wherein receiving the response comprises receiving a random access message that includes the response.

Aspect 56: The method of any of Aspects 33-52, wherein receiving the response comprises receiving a small data transmission that includes the response.

Aspect 57: The method of any of Aspects 33-56, wherein the response is encrypted using layer 1 or layer 2 security.

Aspect 58: The method of any of Aspects 33-57, wherein the request is multicast to a group of devices including the serving device.

Aspect 59: The method of Aspect 58, wherein the request indicates different computing tasks for different devices in the group of devices.

Aspect 60: The method of Aspect 58, wherein the request indicates a same computing task for each device in the group of devices.

Aspect 61: The method of any of Aspects 33-60, further comprising: transmitting, to the serving device, input data for the computing task; and receiving, from the serving device, output data based at least in part on completion of the computing task.

Aspect 62: The method of any of Aspects 33-60, wherein input data for the computing task is included in the request, and the method further comprises: receiving, from the serving device, output data based at least in part on completion of the computing task.

Aspect 63: The method of any of Aspects 33-60, further comprising: transmitting, to the serving device, an instruction to start the computing task.

Aspect 64: The method of any of Aspects 33-60, further comprising: transmitting, to the serving device, a resource allocation associated with at least one additional serving device, wherein the computing task is associated with cooperation between the serving device and the at least one additional serving device.

Aspect 65: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-64.

Aspect 66: An apparatus for wireless communication at a device, the apparatus comprising one or more memories and one or more processors coupled to the one or more memories, the one or more processors configured to cause the device to perform the method of one or more of Aspects 1-64.

Aspect 67: An apparatus for wireless communication, the apparatus comprising at least one means for performing the method of one or more of Aspects 1-64.

Aspect 68: A non-transitory computer-readable medium storing code for wireless communication, the code comprising instructions executable by one or more processors to perform the method of one or more of Aspects 1-64.

Aspect 69: A non-transitory computer-readable medium storing a set of instructions for wireless communication, the set of instructions comprising one or more instructions that, when executed by one or more processors of a device, cause the device to perform the method of one or more of Aspects 1-64.

Aspect 70: A device for wireless communication, the device comprising a processing system that includes one or more processors and one or more memories coupled with the one or more processors, the processing system configured to cause the device to perform the method of one or more of Aspects 1-64.

Aspect 71: An apparatus for wireless communication at a device, the apparatus comprising one or more memories and one or more processors coupled to the one or more memories, the one or more processors individually or collectively configured to cause the device to perform the method of one or more of Aspects 1-64.

Aspect 72: A device comprising an antenna system that includes one or more antennas, and a processing system, coupled with the antenna system, that includes one or more processors and one or more memories that store code for the one or more processors, the processing system configured to cause the device to perform the method of one or more of Aspects 1-64.

Aspect 73: A device comprising an antenna system that includes one or more antennas, and a processing system, coupled with the antenna system, that includes processor circuitry and memory circuitry that stores code for the processor circuitry, the processing system configured to cause the device to perform the method of one or more of Aspects 1-64.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

The term “transmit path” or “transmission path” may refer to a circuit path within a transmitting device along which a signal to be transmitted is constructed and transformed via channel encoding circuitry, modem (modulation) circuitry, RF and analog circuitry, or other circuitry, such that it may be applied to one or more antennas for transmission by a transmitting device (such as an UE 120 or a network node 110) to a receiving device (such as the other of the UE 120 or the network node 110). As used herein, the terms “transmit,” “transmission,” “transmitting,” “transmitted,” or other derivatives thereof, refer to the action of physically emanating, radiating or emitting (herein used interchangeably), by one or more antennas, electromagnetic radiation representing a desired signal (for example, in the form of an OFDM, orthogonal frequency division multiple access (OFDMA), CP-OFDM, DFT-S-OFDM, filtered-OFDM (F-OFDM), on-off keying (OOK), ultra-wideband (UWB), universal filter multi-carrier (UFMC), or other waveform) wirelessly out into the surrounding environment (also referred to as the “wireless medium”) in the form of radio waves at radio frequencies (RFs) (for example, frequencies in the range of 100 kHz to 300 GHz) for reception by a receiving device. This is often referred to as transmitting “over-the-air (OTA),” meaning that the signal, as it propagates, is not confined or guided by a wired or other conductive medium, a fiber optic cable, or other structural channel. When a transmitting device, such as a UE 120 or a network node 110, performs a transmission of an electromagnetic signal OTA, the RF and analog circuitry or other circuitry, such as in an antenna module of the transmitting device, applies the signal to one or more antennas from which the signal is physically transmitted; that is, emitted from an antenna as a radio wave. The term “receive path” or “reception path” may refer to a circuit path along which a signal is received from one or more antennas and transformed via RF and analog circuitry, modem (demodulation) circuitry, channel decoding circuitry or other circuitry for provision to processor circuitry. As used herein, the terms “receive,” “reception,” “receiving,” “received,” or other derivatives thereof, refer to the action of one or more antennas receiving, such as being electrically excited or stimulated by, electromagnetic radiation in the form of radio waves from the surrounding wireless medium. This is often referred to as receiving OTA.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet, such as data or control signaling. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, the term “A or B” as well as the term “A and/or B” may include A only, B only, or a combination of both A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “based on” is equivalent to “based at least in part on” and indicates a non-limiting relationship between elements “a” and “b.” In some aspects, a’ (which may be a variation or example of a) may be responsive to or in response to b’ (which may be a variation or example of b), such as if condition c is met. In some other aspects, a’’ (which may be a variation or example of at least one of a or a’) may be associated with b’’ (which may be a variation or example of at least one of b or b’). In some further aspects, a’’’ (which may be a variation or example of at least one of a or a’ or a’’) may be determined (or any of the other actions encompassed by usage of the word “determining” as described above) in accordance with b’’’ (which may be a variation or example of at least one of b or b’ or b’’). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products. Additionally, even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A serving device, comprising:
one or more antennas; and
a processing system that includes one or more processors and one or more memories that store code and are coupled with the one or more processors, the processing system configured to cause the serving device to:
receive, from a network, a request indicating that the serving device is being requested to perform a computing task on behalf of the network or for a client device; and
transmit, to the network, a response to the request indicating whether the serving device accepts or rejects the request.

2. The serving device of claim 1, wherein the serving device comprises a user equipment or an edge computing device.

3. The serving device of claim 1, wherein, to receive the request, the processing system is configured to cause the serving device to:
receive an indication of one or more computing resources associated with the computing task;
receive an indication of a category of the computing task;
receive an indication of a time constraint associated with the computing task;
receive an indication of a type of the computing task; or
receive an indication of a security protocol associated with the computing task.

4. The serving device of claim 1, wherein the request references a table that defines one or more of:
one or more computing resources associated with the computing task;
a category of the computing task;
a time constraint associated with the computing task;
a type of the computing task; or
a security protocol associated with the computing task.

5. The serving device of claim 1, wherein, to receive the request, the processing system is configured to cause the serving device to:
receive a paging message that includes the request.

6. The serving device of claim 5, wherein the paging message includes a cause value indicating that the paging message is for the computing task.

7. The serving device of claim 5, wherein the processing system is configured to cause the serving device to:
receive a paging early indication that indicates that the paging message including the request will be transmitted.

8. The serving device of claim 5, wherein the processing system is configured to cause the serving device to:
receive information associated with the computing task in a random access message or a small data transmission.

9. The serving device of claim 1, wherein, to transmit the response, the processing system is configured to cause the serving device to:
transmit the response in a set of resources that was indicated by the request.

10. The serving device of claim 1, wherein, to transmit the response, the processing system is configured to cause the serving device to:
transmit a random access message or a small data transmission that includes the response.

11. The serving device of claim 1, wherein the request is multicast to a group of devices including the serving device.

12. The serving device of claim 11, wherein the request indicates different computing tasks for different devices in the group of devices.

13. The serving device of claim 11, wherein the request indicates a same computing task for each device in the group of devices.

14. The serving device of claim 1, wherein the processing system is configured to cause the serving device to:
receive, from the network, input data for the computing task; and
transmit, to the network, output data based at least in part on performing the computing task.

15. The serving device of claim 1, wherein the processing system is configured to cause the serving device to:
perform the computing task using input data included in the request; and
transmit, to the network, output data based at least in part on performing the computing task.

16. The serving device of claim 1, wherein the processing system is configured to cause the serving device to:
receive, from the network, an instruction to start the computing task; and
perform the computing task in response to the instruction.

17. The serving device of claim 1, wherein the processing system is configured to cause the serving device to:
receive, from the network, a resource allocation associated with at least one additional serving device; and
communicate with the at least one additional serving device, using the resource allocation, to perform the computing task.

18. A method of wireless communication performed by a serving device, comprising:
receiving, from a network, a request indicating that the serving device is being requested to perform a computing task on behalf of the network or for a client device; and
transmitting, to the network, a response to the request indicating whether the serving device accepts or rejects the request.

19. The method of claim 18, further comprising:
performing the computing task using input data included in the request; and
transmitting, to the network, output data based at least in part on performing the computing task.

20. A non-transitory computer-readable medium storing a set of instructions for wireless communication, the set of instructions comprising:
one or more instructions that, when executed by one or more processors of a serving device, cause the serving device to:
receive, from a network, a request indicating that the serving device is being requested to perform a computing task on behalf of the network or for a client device; and
transmit, to the network, a response to the request indicating whether the serving device accepts or rejects the request.
